(19) United States
(12) Patent Application Publication
(10) Pub. No.: US 2025/0073871 A1
(43) Pub. Date: Mar. 6, 2025

(54) AUTOMOBILE HOT WATER HOSE JOINT PLIERS

(71) Applicant: Pi-Liang WU, Taichung City (TW)

(72) Inventor: Pi-Liang WU, Taichung City (TW)

(21) Appl. No.: 18/417,615

(22) Filed: Jan. 19, 2024

(30) Foreign Application Priority Data
Aug. 29, 2023 (TW) 112132664

(51) Int. Cl. B25B 27/00; B25B 27/14

(52) U.S. Cl. CPC B25B 27/0035; B25B 27/14

(57) ABSTRACT

An automobile hot water hose pliers is installed to a hot water hose on a tube end of an evaporator of the automobile or dismantle the hot water hose from the tube end. The pliers includes two hand grips. An end of each hand grip is connected and fixed to a plier body. A pivoting part of one plier body is overlapped with the other pivoting part of the other plier body, and the two pivoting parts are pivoted together by a spindle. An elastic element is disposed between the two hand grips, and by elastic force of the elastic element, the two hand grips keep opened normally. Each plier body includes a clipping part, wherein a semi-curved clipping mouth is disposed opposite to the clipping part, and is used to clip a lock ring of the hot water hose joint, thereby rotating the pliers to the lock ring.

### BACKGROUND OF THE INVENTION

### (a) Field of the Invention

The present invention relates to a hand tool, and more particularly to an automobile hot water hose joint pliers.

### (b) Description of the Prior Art

FIG. 1 is an automobile hot water hose joint 10 by which a water hose 14 is connected to a tube end 12 of an evaporator (not shown in the drawing).

The joint 10 is provided with a connection part 13, an end of the connection part 13 is connected and fixed to the water hose 14, whereas the other end of the connection part 13 is provided with a lock ring 15. The lock ring 15 can be rotated clockwise or counterclockwise by a predetermined angle (as shown in the arrow A), so that the lock ring 15 can change between a lock position P1 and an unlock position P2. The lock ring 15 is provided with an identification part 151, and the identification part 151 will appear on the lock position P1 or unlock position P2 for identification by an operator. At the lock position P1, an elastic clamping part (not shown in the drawing) protruded in the lock ring 15 is elastically clamped in an outer wall slot 121 of the tube end 12, so that the joint 10 can be locked on the tube end 12 without escaping. On the other hand, when the lock ring 15 is rotated to the unlock position P2, the elastic clamping part will escape from the outer wall slot 121, and the joint 10 can be separated from the tube end 12.

The abovementioned joint 10 and tube end 12 are disposed in an automobile engine bay. The engine bay is very narrow, and the joint 10 and the tube end 12 are blocked by the automobile electromechanical devices and piping. Therefore, the operator cannot operate by bare hands and will need a customized hand tool when repairing or replacing the water hose.

### SUMMARY OF THE INVENTION

Accordingly, the object of the present invention is to provide a pliers to connect or separate the abovementioned joint and tube end.

The technical features of the present invention are described below. An automobile hot water hose joint pliers is used to install a hot water hose joint on a tube end of an evaporator of the automobile or dismantle the hot water hose joint from the tube end. The pliers include two hand grips, and an end of each hand grip is connected and fixed to a plier body. A pivoting part of one plier body is overlapped with the other pivoting part of the other plier unit, and the two pivoting parts are pivoted together by a spindle. An elastic element is disposed between the two hand grips. By the elastic force of the elastic element, the two hand grips keep opened normally. Each plier body includes a clipping part, and the clipping part maintains an included angle with respect to the plier body. A semi-curved clipping mouth is disposed opposite to the clipping part, and is used to clip the lock ring of the hot water hose joint, which facilitates the pliers to rotate the lock ring.

The efficacy of the present invention is described. The clipping part of the pliers can be extended into the narrow space in the automobile engine bay to clip the lock ring stably, allowing the operator to rotate the lock ring for locking and unlocking easily and effortlessly, so as to install the hot water hose joint on the tube end or dismantle the hot water hose joint from the tube end.

The present invention is primarily used to, but not limited to, install or dismantle the hot water hose joint in the prior art; the present invention can be utilized in the operation of installing or dismantling a water hose and a joint in any narrow space.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an automobile hot water hose joint in a prior art.

FIG. 2 shows an external view of a pliers of the present invention.

FIG. 3 shows a side view of the pliers in FIG. 2.

FIG. 4 shows a side view of the present invention, wherein the pliers is clipped on the hot water hose joint.

FIG. 5 shows a side view of the present invention, wherein the pliers clips and rotates the hot water hose joint.

FIG. 6 shows a side view of the present invention, wherein the pliers clips the hot water hose joint.

FIG. 7 shows a side view of the present invention, wherein the pliers is used to dismantle the hot water hose joint from a tube end.

### DETAILED DESCRIPTION OF THE PREFERRED EMBODIMENTS

To conveniently describe the central idea in the abovementioned summary of the invention, a specific embodiment is manifested. In the embodiment, each kind of different object is depicted according to the scale, dimension, deformation or displacement that is suitable for description, not to be portrayed by the actual scale of element. In addition, in the following description, the elements that are identical or symmetrically configured are represented by the same numerical symbols.

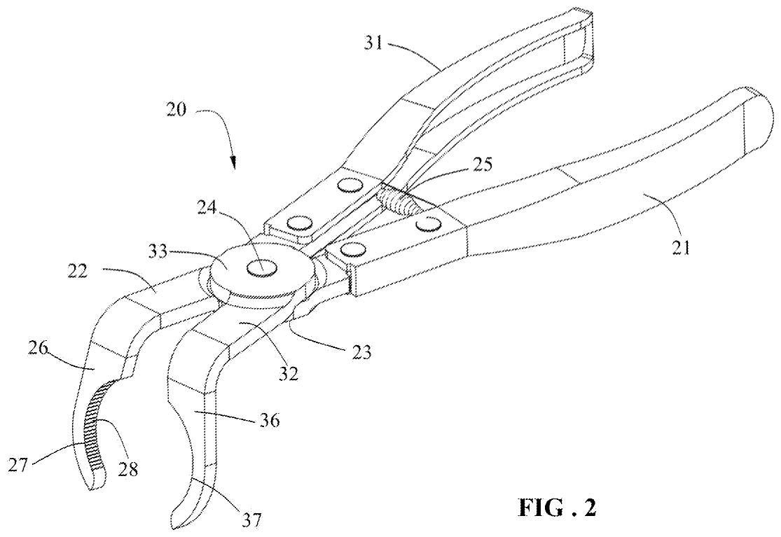

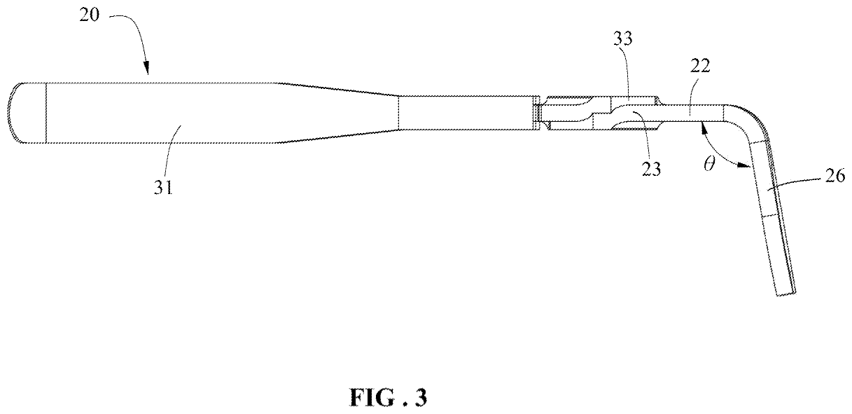

Referring to FIG. 2 and FIG. 3, the present invention discloses a pliers 20 including two hand grips 21, 31, and an end of each hand grip 21 or 31 is connected and fixed to a plier body 22 or 32. A pivoting part 23 or 33 of one plier body 22 or 32 is overlapped with the other pivoting part 23 or 33 of the other plier body 22 or 32, and the two pivoting parts 23, 33 are pivoted together by a spindle 24. An elastic element 25 is disposed between the two hand grips 21, 31, and by the elastic force of the elastic element 25, the two hand grips 21, 31 keep opened normally. Each of the two plier bodies 22, 32 includes a clipping part 26 or 36. The clipping part 26 or 36 maintains an included angle θ with respect to the plier body 22 or 32, and the included angle θ is 90° to 120°, with the preferred angle of 100°. A semi-curved clipping mouth 27 or 37 is disposed opposite to the clipping part 26 or 36, and a curved side wall of the clipping mouth 27 or 37 is provided with an anti-slip embossment 28. The opening and closing of the two hand grips 21, 31 control the opening and closing of the two clipping parts 26, 36 simultaneously.

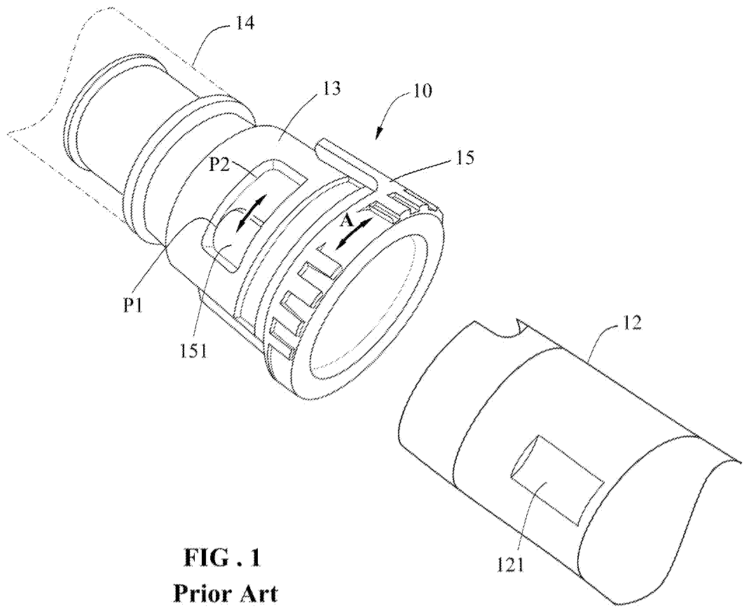

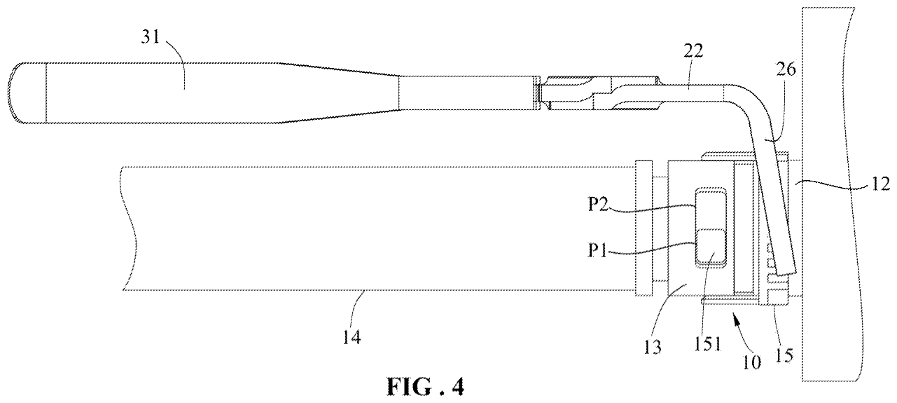

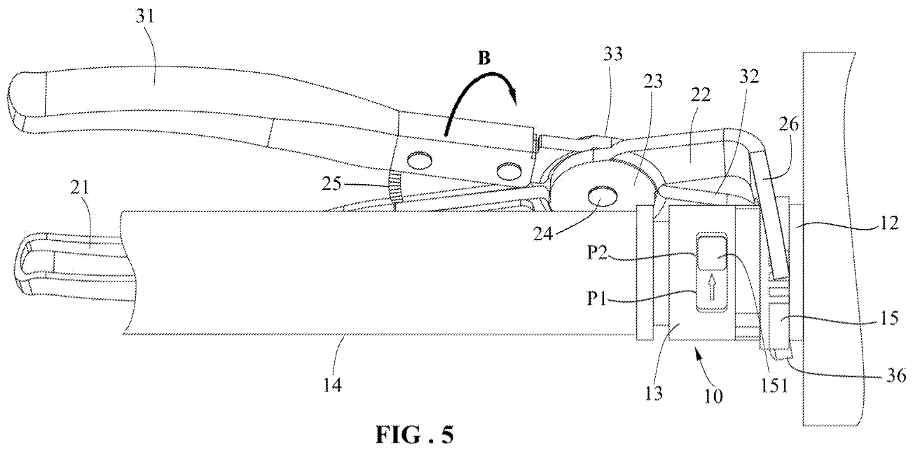

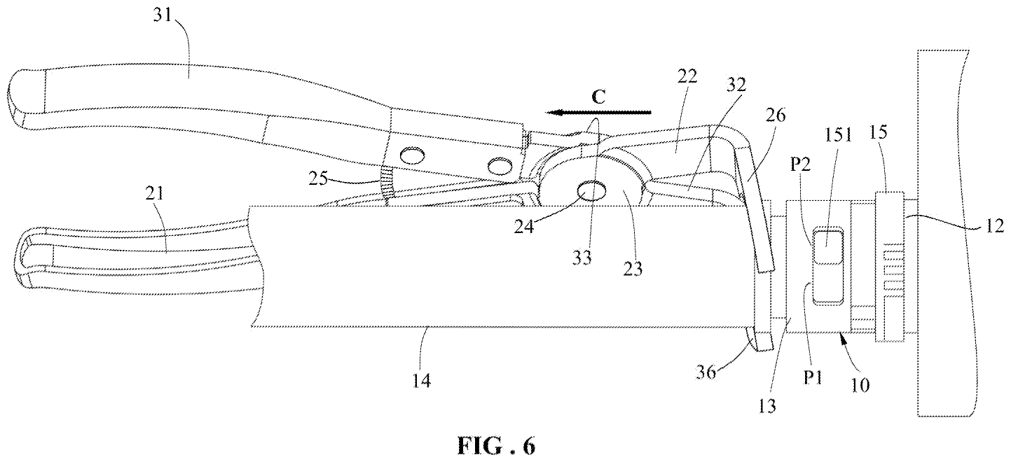

Referring to FIGS. 2 to 7, the pliers 20 is used to install the hot water hose joint 10 in FIG. 1 on the tube end 12 of an evaporator or dismantle the hot water hose joint 10 from the tube end 12. As described in the prior art, the hot water hose joint 10 includes a connection part 13. An end of the connection part 13 is connected and fixed to a water hose 14, and the other end of the connection part 13 is provided with a lock ring 15. The lock ring 15 can be rotated clockwise or counterclockwise by a predetermined angle (as shown in the arrow A), so that the lock ring 15 can change between a lock position P1 and an unlock position P2. The lock ring 15 is provided with an identification part 151 which will appear on the lock position P1 or the unlock position P2 for identification by an operator. On the lock position P1, an elastic clamping part (not shown in the drawing) protruded in the lock ring 15 will be elastically clamped in an outer wall slot 121 on the tube end 12, and the hot water hose joint 10 will be locked on the tube end 12 without escaping. On the other hand, when the lock ring 15 is rotated to the unlock position P2, the elastic clamping part will escape from the outer wall slot 121, and the hot water hose joint 10 can be separated from the tube end 12.

Referring to FIGS. 2 to 7, the operator holds the hand grips 21, 31 to control the pliers 20, clamping the lock ring 15 of the hot water hose joint 10 by the clipping mouths 27, 37.

Referring to FIGS. 2 to 7, the pliers 20 is used to rotate the lock ring 15 by a predetermined angle (as shown in the arrow B), enabling the lock ring 15 to change from the lock position P1 to the unlock position P2.

Referring to FIGS. 2 to 7, the clipping mouths 27, 37 are released, and the pliers 20 is moved by a predetermined distance along the hot water hose joint 10, enabling the clipping mouths 27, 37 to escape from the lock ring 15 and to clip the connection part 13. The direction of movement of the pliers 20 is as shown in the arrow C.

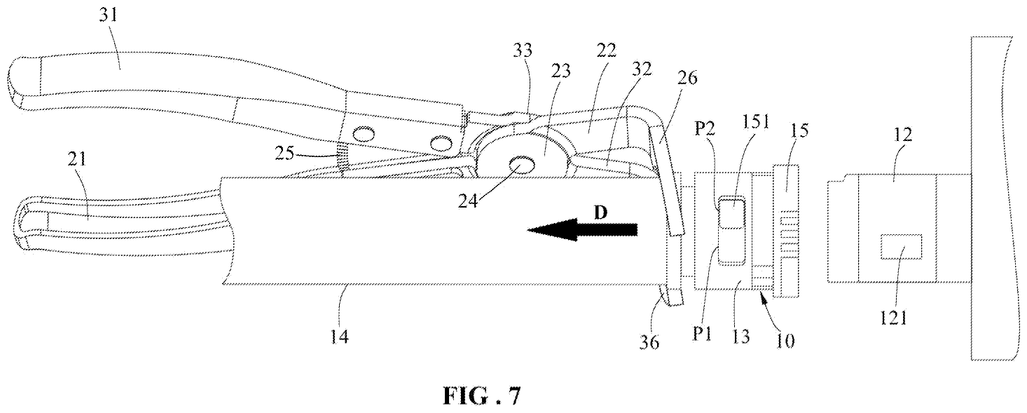

Referring to FIG. 7, the operator exerts a force to pull the hot water hose joint 10, enabling the hot water hose joint 10 to escape from the tube end 12. The direction of pull is as shown in the arrow D.

The abovementioned operational procedure is implemented reversely to install the hot water hose joint 10 on the tube end 12.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An automobile hot water hose joint pliers, being used to install a hot water hose joint on a tube end of an evaporator of the automobile or dismantle the hot water hose joint from the tube end, wherein the hot water hose joint comprises a connection part, an end of the connection part is connected and fixed to a water hose, the other end of the connection part is provided with a lock ring, and the lock ring is rotated clockwise or counterclockwise by a predetermined angle to change between a lock position and an unlock position; on the lock position, the hot water hose joint being locked on the tube end without escaping; on the unlock position, the hot water hose joint escaping from the tube end; the pliers including two hand grips, with an end of each hand grip being connected and fixed to a plier body, a pivoting part of one plier body being overlapped with the other pivoting part of the other plier body, and the two pivoting parts being pivoted together by a spindle; each of the two plier bodies comprises a clipping part, the clipping part maintains an included angle with respect to the plier body, a semi-curved clipping mouth is disposed opposite to the clipping part, and the clipping mouth is used to clip the lock ring, which facilitates the pliers to rotate the lock ring.

2. The automobile hot water hose joint pliers as claimed in claim 1, wherein the included angle is 90° to 120°.

3. The automobile hot water hose joint pliers as claimed in claim 1, wherein the included angle is 100°.

4. The automobile hot water hose joint pliers as claimed in claim 1, wherein a curved side wall of the clipping mouth is provided with an anti-slip embossment.

5. The automobile hot water hose joint pliers as claimed in claim 1, wherein an elastic element is disposed between the two hand grips, and by elastic force of the elastic element, the two hand grips keep opened normally.
